(19) United States
(12) Patent Application Publication
(10) Pub. No.: US 2011/0221447 A1
(43) Pub. Date: Sep. 15, 2011

(54) SENSOR SYSTEM FOR DETECTING ANALYTES IN LOW CONCENTRATION

(75) Inventor: Bentien Anders, Skodstrup (DK)

(73) Assignee: Grundfos Management a/s, Bjerringbro (DK)

(21) Appl. No.: 12/673,854

(22) PCT Filed: Aug. 15, 2008
(86) PCT No.: PCT/EP2008/006732

§ 371 Date: Feb. 17, 2010

(30) Foreign Application Priority Data
Aug. 18, 2007 (EP) 07016223.5

(51) Int. Cl. G01N 27/62

(52) U.S. Cl. 324/459

(57) ABSTRACT

The invention relates to a sensor system (2) designed for detecting analytes in low concentration in water. The system (2) comprises at least one sensor element (4) with at least one detection region (6) which is designed for the detection of at least one analyte on its surface, and a voltage source (14) by way of which, the detection region (6) of the sensor element (4) may be subjected to an electrical voltage.

### CROSS-REFERENCE TO RELATED APPLICATIONS

This application is a Section 371 of International Application No. PCT/EP2008/006732, filed Aug. 15, 2008, which was published in the English language on Feb. 26, 2009, under International Publication No. WO 2009/024301 A1 and the disclosure of which is incorporated herein by reference.

### BACKGROUND OF THE INVENTION

The invention relates to a sensor system for detecting analytes in a low concentration, as well as to a corresponding method for detecting analytes in a low concentration.

In many cases of application, it is necessary to be able to detect or ascertain certain substances, e.g. in fluids. These substances may for example be poisons, pesticides or other harmful substances in water, in particular drinking water. Furthermore, it is often necessary to detect or ascertain very low concentrations of such substances.

Various analysis methods are known from the state of the art, which may be applied for this. These for example are atom absorption spectroscopy (AAS), atom emission spectroscopy (AES) or atom mass spectroscopy (AMS), as are disclosed, for example, in Today's Chemist at Work 8, 10, 42 (1999). The atom mass spectroscopy represents the most sensitive method. All three methods however require extremely expensive installations. Such installations are not suitable for real-time monitoring, for example with a drinking water supply.

### BRIEF SUMMARY OF THE INVENTION

It is the object of the invention to provide an adequately exact or sensitive sensor system for detecting analytes in small concentrations in water, as well as a corresponding method for detecting analytes in small concentrations in water, which is less expensive and in particular permits a real-time monitoring.

The sensor system according to the invention serves for detecting analytes in the form of ions in small concentration, in particular in water, particularly drinking water. The sensor system comprises at least one sensor element with at least one detection region. The detection region is designed such that it may detect or ascertain at least one analyte on its surface. This means that with the sensor system according to the invention, the recognition that an analyte to be detected is present in the surroundings, is effected by the sensor element at its detection region. Thereby, the sensor element is designed at least in a manner such that it may recognise the presence of an analyte at all events, but is preferably designed such that it may also detect the quantity of the analyte.

According to the invention, the sensor system is furthermore designed such that a charging source or voltage source is provided, by way of which the detection region of the sensor element may be subjected to an electrical voltage or charging. A potential difference between the detection region and the surroundings may be produced by way of this, by which means analytes in the environment, e.g. in a surrounding fluid, may be electrochemically accumulated on the detection region. The analyte may then be detected by the sensor element.

By way of this system, one also succeeds its providing of a greater concentration of this analyte at the detection region of the sensor element, even with a small concentration of the analyte to be detected, wherein this concentration is simpler to detect or ascertain. This permits the application of less expensive sensor elements which per se would not have the required sensitivity for detection of the small concentrations of the analyte.

A further advantage lies in the fact that the process is reversible, i.e. one may succeed in removing the accumulated substances or ions from the surface of the detection region again, e.g. by way of switching off or changing the polarity, so that the detection region is set back again into its initial condition. This permits a permanent application of the sensor system without the exchange of sensor elements becoming necessary.

Moreover, one may very simply control or detect which substances or ions accumulate on the detection region with the system according to the invention. Inasmuch as this is concerned, the detection region does not need to be designed in a special manner, in order to attract certain substances to be detected or to favour the accumulation of these substances or analytes.

A movement or concentration of the analytes to be detected, in the surrounding fluid is only achieved when the potential difference between the detection region and the surroundings is so large that the ionization potential of the analyte to be detected is exceeded. Inasmuch as this is concerned, one may control which analytes accumulate on the detection region of the surface by way of the voltage applied into the detection region, i.e. the potential difference. With the knowledge of the ionization potential of certain substances or analytes, when detecting the prevailing (current) potential difference and simultaneous detection of the measurement result of the sensor element, this measurement may be attributed to certain analytes, whose ionization potential corresponds to the detected potential difference. This may also be effected by way of a suitable evaluation device.

The sensor element itself is a microcantilever sensor. The additional arrangement of the voltage source, which produces a potential difference between the detection region of the sensor element and the surroundings, merely serves for accumulating the substances or analytes to be detected, on the sensor element, so that in this manner they may be detected by the sensor element in a small concentration. By way of the potential difference, one succeeds in the concentration of the analytes or ions to be detected, on the sensor element, being greater than it is in the remaining regions of the fluid. This permits known sensor elements, which are otherwise less or not sufficiently sensitive, to be able to be applied, but despite this permits the desired high sensitivity to be achieved. Moreover, one may also make do without non-reversible systems for accumulating or concentration the analyte to be detected, on the sensor.

A microcantilever sensor is based on changes of the surface tension when an analyte is accumulated on the surface. The detection or measurement of this change is either carried out on the basis of the change of the resonant frequency or on account of the bending of the microcantilever. This may be measured by way of a piezoelectric material or by way of reflection of a laser beam. Such sensors react very sensitively to mass changes and may detect mass changes of significantly less than 1 pg (picogram).

Preferably, the voltage source is connected to the detection region and to a counter-electrode in a manner such that the voltage produced by the voltage source may be applied between the detection region and the counter-electrode. Thereby, the counter-electrode as well as the detection region is located in the fluid, in which the detection of the analyte is to take place. Instead of the counter-electrode, the voltage or potential difference may also be applied between the detection region and earth, for example also the surrounding wall of a tube conduit. Moreover, an electrical charging may be brought to the detection region also in another manner.

The voltage produced by the voltage source, as specified, preferably corresponds to the ionization potential of an analyte to be detected or is selected higher than this ionization potential. An ionization of the analyte to be detected takes place on exceeding the ionization potential so that this analyte may be moved towards the detection region on account of its charging and accumulate on this. The presence and, as the case may be, the quantity of the analyte accumulated there may be detected at the detection region.

Further preferably, the voltage source is designed in a manner such that the charging or voltage may be changed in magnitude and/or polarity, and in particular may be changed with regard to its temporal course. By way of this, it is possible to change the voltage such that different ionization potentials may be achieved, in order to accumulate different analytes on the detection region of the sensor element. One may detect different analytes with one and the same universal sensor element by way of this. Moreover as described above, it is also possible to remove the analyte accumulated on the surface of the detection region, away from this again by way of reducing the voltage below the ionization potential of the analyte or even reversing the polarity of the voltage. Thus a reversible process may be achieved. One may thus achieve a quasi continuous detection of analyte in a medium and fluid if then, in the temporal course, the voltage periodically reaches or exceeds the ionization potential of an analyte to be detected and then later falls short of this.

Particularly preferably, the detection of the analyte is effected in a stripping process, with which the voltage course is temporally effected such that the voltage firstly increases beyond the ionization potential or up to the ionization potential of the analyte to be detected, such that this is accumulated on the detection region. Subsequently, the voltage is reduced again so that it falls short of the ionization potential, wherein the analyte or ions are removed again from the detection region. Thereby, the difference of the condition with the accumulated analyte and subsequently with removed analyte may be detected by the sensor element and in particular also the concentration and quantity of the analyte may be determined by way of this.

Further preferably, the sensor element is designed in a manner such that it produces an output signal, which is dependent on the concentration of the analyte on this detection region. In this manner, one may not only determine the presence of the analyte, but also the quantity, i.e. the concentration of the analyte in the surrounding medium.

An evaluation device is particularly preferably provided, which is designed for the detection and common evaluation of an output signal of the sensor element and the prevailing voltage which prevails on the detection region of the sensor element. In this manner, as specified above, it is possible to unambiguously attribute the value detected by the sensor element to a certain analyte, since the prevailing voltage may be measured. Thereby, in particular, the ionization potential of the analyte to be determined is fallen short of or exceeded in the course of the measurement, so that, as the case may be, a signal difference between the condition below the ionization potential and at or above the ionization potential may be detected at the sensor element. In this manner, the presence of a certain analyte may be detected with this ionization potential and in particular, if the sensor element permits a quantitative measurement, the concentration of the analyte in the surrounding fluid may also be detected.

Ideally, the voltage is continuously varied, so that at least the ionization potential of a certain analyte is regularly exceeded and fallen short of, so that a quasi continuous detection of this analyte is possible. Further preferably, it is possible to vary the voltage such that the ionization potentials of different analytes are consecutively exceeded and fallen short of. In a current (real-time) manner, the reading difference of the sensor element may be detected on exceeding or falling short of a certain ionization potential, in order to determine the presence and, as the case may be, the concentration of the attributed analyte precisely with this ionization potential. Different analytes may be detected with one and the same process and with one and the same sensor element in this manner.

According to a further preferred embodiment, a voltage measurement system for detecting the electrical voltage between the sensor element and the surroundings is provided. This voltage measurement system may be integrated into the voltage source or into the control of the voltage source, so that the value of the voltage is know directly on producing the voltage, and may be made available to an evaluation device. Alternatively, one may provide a separate voltage measurement system, which preferably continuously detects the voltage difference prevailing at the detection region.

A reference electrode may further preferably be provided for this, and the voltage measurement system may be designed for detecting the voltage between this reference electrode and the detection region of the sensor element. The reference electrode in a special embodiment may simultaneously serve as a counter-electrode, between which and the detection region the voltage is applied.

Particularly preferably, the voltage source is designed in a manner such that the voltage produced by the voltage source may be changed in a manner such that in the temporal course, it firstly increases rapidly, i.e. preferably directly from zero to a predefined value, and then drops from this in a slower manner, preferably in a linear manner. Particularly preferably, the actual measurement is then carried out during the drop of the voltage. For this, the voltage is firstly lifted to a value above the ionization potential of an analyte to be detected, and then slowly reduced, so that it drops below the ionization potential again. A jump in the output signal of the sensor element then occurs in the case that the respective analyte is present in the fluid to be analysed, and this jump indicates the presence of the respective analyte and, as the case may be, permits a quantitative determination of the analyte. In other words, here the measurement or detection of the analyte at the sensor element is carried out at the moment when the analyte accumulated on the detection region is removed from the detection region. Vice versa, one may also carry out a method, with which the measurement is effected when the analyte is accumulated on the detection region.

A control device is further preferably provided, which for the preferable automatic detection of at least one analyte and preferably of several analytes, controls the voltage source for the provision of desired characteristic voltages or voltage courses. Thereby, the control device may be integrated into an evaluation device, which simultaneously detects the prevailing potential difference and the output signal of the sensor element. The voltage is preferably continuously varied, in order, as described above, to concentrate or accumulate analytes at the detection region of the sensor element and to remove them again from this.

The invention further relates to a method for detecting analytes or ions in small concentration in water, in particular in drinking water. According to the invention, with this method, one uses a sensor element which is designed for detecting at least one analyte. Thereby, this sensor element is designed as a microcantilever as described above. This may detect the precence of molecules or ions on a surface in a simple manner. The accumulation of these molecules or ions according to the invention is efected by way of a simultaneously applying an electrical voltage to a detection region of the sensor element, or the detection region being electrically charged with respect to the surroundings. The detection region of the sensor is that region at which the actual detection of the accumulated substances or molecules takes place. A potential difference is created by way of the applied voltage, by way of which potential difference the analytes to be detected are moved towards the detection region and are concentrated or accumulated on this. Moreover, preferably the analyte may also be removed again from the detection region by way of a suitable choice of the voltage. In other words, the voltage serves for bringing the analyte to be detected, to the detection region of the sensor element and concentrating it there, so that it may be detected by the sensor element.

For this, the electrical voltage is preferably selected in a manner such that it corresponds to the ionization potential of an analyte to be detected, or lies above this ionization potential. The analyte is ionized by way of this and on account of its charging, may be attracted to the surface of the detection region and be accumulated there.

Further preferably, the voltage varies in magnitude and/or polarity, wherein the voltage, in its temporal course, reaches or exceeds the ionization potential of an analyte to be detected. A continuous implementation of the method is possible by way of this, since the analyte may be accumulated on the surface of the detection region and subsequently be removed from this again by way of changing the voltage. Thereby, as described above, the measurement may be effected during the accumulation or also during the removal.

Further preferably, an output signal of the sensor element is attributed to a certain voltage which prevails at the same time at the detection region. In this manner, one may determine which or what type of analyte prevails on the surface of the detection region. This identification is effected via the characteristic ionization potential of the analyte. If the voltage lies in this region or has fallen short of or exceeded this potential during the measuring which has just been carried out, then the reading of the sensor element may be unambiguously attributed to the analyte with this defined ionization potential.

According to a particularly preferred method, the temporal course of the voltage is selected in a manner such that the voltage is firstly directly lifted to a maximal value above the ionization potential of at least one analyte to be detected. This leads to the ionization of the analyte and to this accumulating on the surface of the detection region. Subsequently, the voltage is reduced again proceeding from this maximal value, which means it drops preferably in a linear manner, wherein the ionization potential is again fallen short of. As soon as the ionization potential is fallen short of, the analytes again detach from the surface of the detection region, so that the reading of the sensor element changes abruptly. This reading difference may be used for determining the presence of an analyte with the characteristic ionization potential, wherein preferably the quantity, which is to say the concentration of the analyte in the surrounding fluid, may be determined from the reading difference. It is further preferable to lift the voltage to a maximal value above a multitude of ionization potentials of different analytes, and then to lower it in a manner such that the individual ionization potentials are successively fallen short of, wherein with each falling-short of an ionization potential, a measurement for the analyte with precisely this ionization potential is carried out. Thus different analytes may be carried out in a measurement procedure. This procedure may be repeated in a directly consecutive, preferably continuous manner, so that a quasi continuous measurement may be carried out.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 schematically, a first preferred embodiment of the invention whilst using a microcantilever sensor,

FIGS. 2a and 2b schematically, the manner of functioning of the microcantilever sensor,

FIG. 3a the voltage course,

FIG. 3b the bending curve of a microcantilever sensor with the voltage course according to FIG. 3a,

FIGS. 4a and c voltage courses according to a further preferred embodiment,

FIGS. 4b and d the bending curves of a microcantilever sensor which belong the voltage courses according to FIGS. 4a and c.

### DETAILED DESCRIPTION OF THE INVENTION

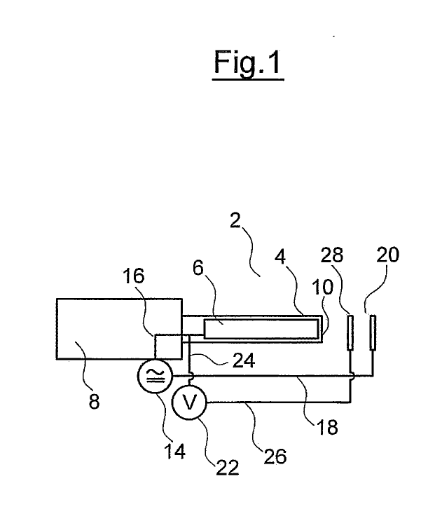

The sensor system 2 according to FIG. 1 comprises a sensor element 4 in the form of a microcantilever. A detection region 6 is formed on the microcantilever 4 as an operating electrode. The microcantilever 4 at its first end is articulated on a base element 8. The opposite free longitudinal end 10 is freely movable, i.e. the microcantilever 4 may bend proceeding from the articulation region on the base element 8.

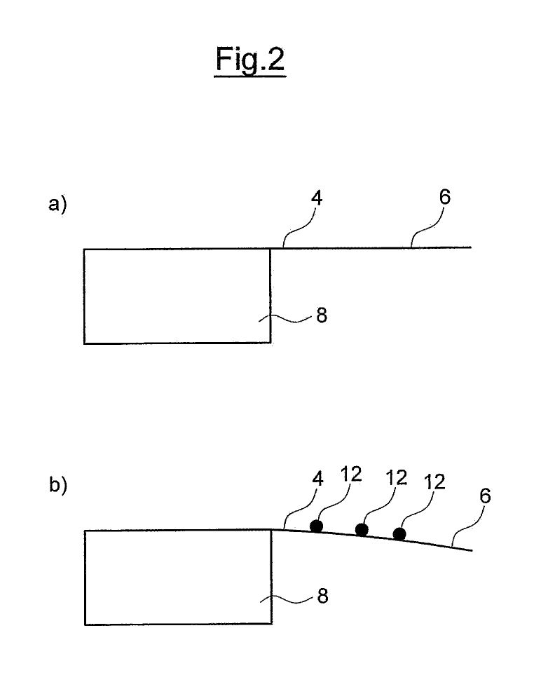

The detection of certain analytes by way of the sensor element 4 is effected as is schematically shown in FIGS. 2a and 2b. The idle condition of the sensor element 4 is shown in FIG. 2a, it extends essentially in a straight line proceeding from the base element 8. No elements are accumulated on the surface of the sensor element 4, i.e. on the detection region 6. FIG. 2b shows a condition, in which elements or molecules 12 of an analyte are accumulated on the detection region 6. The accumulation of the molecules 12 on the surface of the sensor element 4 leads to a change of the surface tension and to a bending or deflection of the microcantilever. This deflection of the sensor element or microcantilever 4 may for example be measured by way of piezoelectric elements, which are arranged on or in the sensor element 4. Alternatively e.g. it is also possible to determine this bending by way of reflection of a laser beam on the sensor element 4.

The accumulation of the molecules 12 of the analyte on the surface of the detection region 6 is effected in an electrochemical manner. For this, a voltage source or a voltage generator 14 is provided, which is connected via a first conductor 16 to the detection region 6 which forms the operating electrode. The voltage generator 14 is connected to a counter-electrode 20 via a second conductor 18. The detection region 6 as well as the counter-electrode 20 is immersed into the fluid, in which analytes are to be determined. In this manner, a voltage may be produced between the detection region 6 and the counter-electrode 20 by way of the voltage generator 14, i.e. the detection region 6 is electrically charged with respect to the surroundings. The potential difference between the detection region 6 and the surroundings leads to the ionization of an analyte, when the ionization potential of an analyte is exceeded by the voltage between the detection region 6 and the electrical potential of the surroundings, whereupon this analyte migrates to the detection region 6 and is accumulated there in an electrochemical manner and thus leads to the deflection of the microcantilever 4 which is shown in FIG. 2b. This process is reversible by way of the voltage which is produced by the voltage generator 14, being reduced again below the ionization potential of this analyte. The molecules of the analyte then move away from the detection region 6 again.

In the embodiment example according to FIG. 1, moreover a voltage measurement system 22 is provided, which is connected to the detection region 6 via a first conductor 24. The voltage measurement system 22 is connected via a second conductor 26 to a reference electrode 28 which is likewise immersed into the fluid, in which the analytes to be ascertained are located. An analyte may be identified in a precise manner by way of its ionization potential on account of the voltage detected between the reference electrode 28 and the detection region 6. A counter-electrode 20 is used in the shown example. However, one may make do without this counter-electrode 20. The detection region 6 may also be electrically charged with respect to the surroundings, also without the counter-electrode 20. For example, it is conceivable for the reference electrode 28 to simultaneously serve as a counter-electrode.

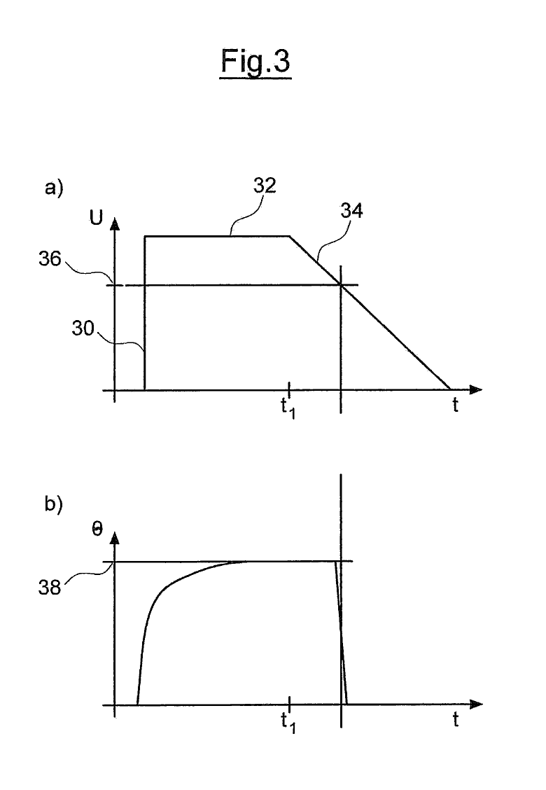

The detection of the voltage difference between the detection region 6 and the reference electrode 28 permits the measurement result of the sensor element 4 to be attributed to a certain analyte by way of ascertaining at which voltage the measurement result of the sensor element 4 changes. If this voltage corresponds to the ionization potential of a certain analyte, then from this one may deduce that the change of the measurement result which has been simultaneously detected by the sensor element 4, originates precisely from this analyte with the ionization potential detected by the voltage measurement system 22. The function of this measurement is described in more detail by way of FIGS. 3a and 3b. FIG. 3a shows the voltage course U over the time t, as is produced by the voltage generator 14 between the detection region 6 and the surroundings, and is detected between the detection region 6 and the reference electrode 28 by way of the voltage measurement system 22. FIG. 3b shows the associated deflection θ of the sensor element 4 plotted over the time t. The voltage U is firstly lifted in a first section 30 of the voltage course essentially directly to the voltage level, which prevails in the second section 32 of the voltage course such that the ionization potential 36 at least of one analyte to be determined is exceeded. In the second section 32 of the voltage curve, the voltage is firstly kept constant at the level above the ionization potential 36 up to the point in time t₁. An increasing number of molecules 12 of the analyte accumulate on the sensor element 4 after exceeding the ionization potential, as is shown in FIG. 2b. This leads to an increasing deflection θ of the sensor element 4 until it reaches its maximum value 38. Proceeding from the point in time t₁, the voltage is then reduced linearly to zero in a third section 34 of the voltage curve, wherein this reduction of the voltage is effected significantly more slowly than the lifting of the voltage in the first section 30 of the voltage curve 34. If the voltage in the third section 34 of the voltage course falls lower than the ionization potential 36, this leads to the analytes or molecules 12 accumulated on the detection region 36 being very quickly removed again, which is why the bending angle θ at this point in time drops very rapidly to 0, as is to be seen in FIG. 3b. With a suitable calibration of the sensor element 4, one may deduce the concentration of the analyte with the ionization potential 36 in the surrounding fluid, from the maximal bending angle 38 before falling short of the ionization potential 36, and from the bending angle θ after the falling-short, (ideally=0).

This voltage course shown in FIG. 3a may be periodically repeated, so that a quasi continuous measurement in the fluid may be carried out. If the voltage course is selected such that several ionization potentials of different analytes lying at different potential levels, are exceeded on lifting the voltage in the first section 30 of the voltage curve, then several jumps in the curve of the bending angle θ may occur with the subsequent reduction of the voltage in the third section 34 of the voltage curve, if in each case an ionization potential of a certain analyte was fallen short of, and this analyte was present in the fluid. Thus several analytes may be detected simultaneously in a voltage run.

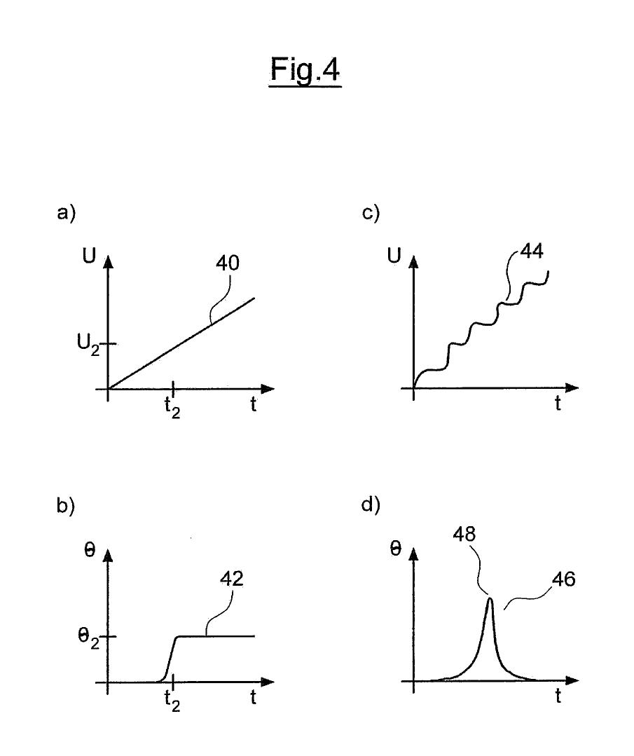

FIG. 4a and FIG. 4b once again show the voltage course 40 plotted against the time t, when the voltage U between the detection region 6 and the surroundings increases in a slow linear manner. FIG. 4b shows the associated course 42 of the bending angle θ. One may recognise that a jump in the course 42 of the bending angle θ occurs when the ionization potential U₂ of a certain analyte is fallen short of at the point in time t₂, i.e. the sensor element 4 at the point in time t₂ is deflected by way of accumulation of the respective analyte and reaches the bending angle θ₂.

FIG. 4c shows one possible temporal course of the potential difference between the detection region 6 and the reference electrode 28 with the use of alternating voltage, wherein here the alternating voltage is increased linearly over time. The course 44 of the alternating voltage signal is the sum of slowly increasing direct voltage signal and of an alternating voltage signal with a certain constant frequency. Thereby, the amplitude of the alternating voltage may be selected small in comparison to the change of the direct voltage over the time t. FIG. 4d shows the associated course 46 of the bending angle θ of the sensor element 4 with an accumulation of an analyte 12. The bending angle θ of the microcantilever 4 is likewise the sum of a direct voltage component and of an alternating voltage component which oscillates with the same frequency as the alternating voltage according to FIG. 4c. FIG. 4d shows only the amplitude of the alternating voltage component which has its maximal value 48 when the applied voltage between the detection region 6 and the reference voltage 28 exceeds the ionization potential of a specific analyte.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1-16. (canceled)

17. A sensor system (2) designed for detecting analytes in low concentration in water, comprising at least one sensor element (4) in the form of a microcantilever sensor with at least one detection region (6), which is designed for the detection of at least one analyte on its surface, and a voltage source (14), by way of which, the detection region (6) of the sensor element (4) may be subjected to an electrical voltage.

18. The sensor system according to claim 17, wherein the voltage source (14) is connected to the detection region (6) and to a counter-electrode (20), in a manner such that the voltage produced by the voltage source (14) may be applied between the detection region (6) and the counter-electrode (20).

19. The sensor system according to claim 17, wherein the voltage produced by the voltage source (14) corresponds to the ionization potential (36) of an analyte (12) to be detected, or is higher than this ionization potential (36).

20. The sensor system according to claim 17, wherein the voltage source (14) is designed in a manner such that the voltage may be changed in magnitude and/or polarity and may be changed in particular in the temporal course.

21. The sensor system according to claim 17, wherein the sensor element (4) is designed in a manner such that it produces an output signal, which is dependent on the concentration of the analyte (12) on the detection region (6).

22. The sensor system according to claim 17, wherein an evaluation device is provided, which is designed for the detection and common evaluation of an output signal of the sensor element (4) and of the prevailing voltage, which is present on the detection region (6) of the sensor element (4).

23. The sensor system according to claim 17, wherein a voltage measurement system (22) is provided for detecting the voltage between the sensor element (4) and the surroundings.

24. The sensor system according to claim 23, wherein a reference electrode (28) is provided and the voltage measurement system (22) is designed for detecting the voltage between this reference electrode (28) and the detection region (6) of the sensor element (4).

25. The sensor system according to claim 17, wherein the voltage produced by the voltage source (14) may be changed in a manner such that in the temporal course, it firstly increases rapidly to a defined value (32) and from this drops more slowly, preferably in a linear manner.

26. The sensor system according to claim 17, wherein a control device is provided, which controls the voltage source (14) for the provision of certain characteristic voltages or voltage courses, for the preferably automatic detection of at least one analyte and preferably of several analytes.

27. A method for detecting analytes in a small concentration in water, with which a microcantilever sensor is applied as a sensor element (4), which is designed for detecting at least one analyte (12), wherein simultaneously an electrical voltage is applied to a detection region (6) of the sensor element (4), in order to accumulate an analyte (12) to be detected, on the detection region (6) and preferably to also remove it again from the detection region (6).

28. The method according to claim 27, wherein the electrical voltage is selected in a manner such that it corresponds to the ionization potential (36) of an analyte (12) to be detected, or lies above this ionization potential (36).

29. The method according to claim 27, wherein the voltage is varied in magnitude and/or polarity, wherein the voltage in the temporal course reaches the ionization potential (36) of an analyte (12) to be detected, or exceeds this.

30. The method according to claim 27, wherein an output signal of the sensor element (4) is assigned to a certain voltage which prevails at the detection region.

31. The method according to claim 27, wherein a temporal course of the voltage is applied, with which the voltage firstly increases to a maximal value (32) above the ionization potential (36) of at least one analyte (12) to be detected, and then proceeding from this maximal value (32) drops again below the ionization potential (36).

32. The method according to claim 31, wherein the detection of the analyte (12) on the detection region (6) is effected whilst the voltage drops from the maximal value (32).
